(19) United States
(12) Patent Application Publication
(10) Pub. No.: US 2003/0104960 A1
(43) Pub. Date: Jun. 5, 2003

(54) Liquid cleaning composition for polymer reactor scale

(76) Inventor: James E. Opre, Downers Grove, IL (US)

Correspondence Address: WELSH & KATZ, LTD, 120 S RIVERSIDE PLAZA, 22ND FLOOR, CHICAGO, IL, 60606, US

(21) Appl. No.: 09/997,891

(22) Filed: Nov. 30, 2001

(51) Int. Cl. C11D 1/00; C09D 9/00

(52) U.S. Cl. 510/201

(57) ABSTRACT

A solvent composition that is effective inter alia for removing polymerization scale, and particularly SAN scale is disclosed that comprises a mixture of at least five ingredients. Those ingredients include (i) about 30 to about 50 weight percent of C₁-C₄ alkyl esters of mixed C₃-C₁₀ dibasic acids, (ii) about 20 to about 40 weight percent, dimethyl sulfoxide (DMSO), (iii) about 15 to about 25 weight percent of a C₂-C₄ carbonate, (iv) about 5 to about 15 weight percent of a C₁-C₄ ester of lactic acid, and (v) about 0.2 to about 5 weight percent of a tertiary amine having a boiling point of about 130° C. to about 370° C. at one atmosphere of pressure, and preferably about 0.5 weight percent of that amine.

### BACKGROUND ART

During the commercial production of styrene-acrylonitrile (SAN) copolymer resin, it is common for the processing equipment to become fouled with styrene-acrylonitrile scale. This SAN scale is a physical buildup of SAN resin materials having a broad ratio of its two component raw materials, styrene resin and acrylonitrile resin. SAN scale, which has high styrene content, is physically very hard and adheres strongly, to processing equipment surfaces. SAN scale, which has a high acrylonitrile, content is a soft, sticky, rubbery material and is difficult to dissolve.

Other polymer production reactors and process equipment such as screens also undergo similar polymerization scale formation. For example, polycarbonate production reactors routinely scale, and screens and other process equipment that are used in high density or low density polyethylene manufacture also scale and get plugged with the respective polymers. These reactors and process equipment are periodically shut down and cleaned with solvents.

Currently, most such reactors and process equipment are cleaned by dimethyl formamide (DMF), an environmentally hazardous solvent. For example, for SAN reactor cleaning, DMF is cycled through a scaled reactor and the resin is dissolved away. The spent solvent undergoes a vacuum distillation to primarily recover and recycle the DMF back to the reactor. Typically, the cleaning and distillation are done at a temperature of around 125° C., and such a cleaning operation takes 24 hours.

Ethyl Lactate and other lactate esters are environmentally benign, non-toxic solvents obtained from renewable carbohydrates via fermentation and separations processes. Ethyl lactate for example, has very good solvent properties and a characteristic odor.

Lactate esters can be blended with fatty acid esters and other ester containing solvents to provide biosolvent blends with enhanced solvating, cleaning and penetration properties. For example U.S. Pat. No. 6,096,699 and No. 6,191,087 teach that lactate esters such as ethyl lactate blended with fatty acid esters such as methyl esters of soy oil fatty acids can be used for a variety of solvent cleaning, metal degreasing, paint and varnish removal applications. Co-assigned U.S. Pat. No. 6,284,720 teaches that lactate esters and fatty acid esters can also be blended with dibasic esters such as dimethyl succinate, dimethyl adipate and glutarate and various surfactants to provide solvent cleaners that are particularly effective in cleaning printing machinery.

DMF, because of its toxicity and environmental hazards, is being phased for these uses and the polymer manufacturers will no longer be able to use it. However, heretofore, there has not bee a suitable replacement solvent. Criteria for a replacement solvent include improved health/environmental profile vs. DMF and reduced cleaning cycle time vs. DMF. Recyclability of the solvent via distillation for reuse is also desirable, but of less importance. The disclosure that follows provides one answer to use of DMF as a solvent of choice for removal of SAN scale that meets the above criteria for replacing DMF.

### BRIEF SUMMARY OF THE INVENTION

The present invention relates to a solvent composition for removing polymerization scale, and particularly SAN scale. A contemplated composition comprises a mixture of at least five ingredients that include (i) about 30 to about 50 weight percent of C₁-C₄ alkyl esters of mixed C₃-C₁₀ dibasic acids, which are preferably methyl esters of mixed C₄-C₆ dibasic acid esters present at about 30 weight percent (ii) about 20 to about 40 weight percent, and preferably about 30 weight percent, dimethyl sulfoxide (DMSO), (iii) about 15 to about 25 weight percent of a C₂-C₄ carbonate, and preferably about 20 weight percent of propylene carbonate, (iv) about 5 to about 15 weight percent of a C₁-C₄ ester of lactic acid, and preferably about 10 weight percent of ethyl lactate, and (v) about 0.2 to about 5 weight percent of a tertiary amine having a boiling point of about 130° C. to about 370° C. at one atmosphere of pressure, and preferably about 0.5 weight percent of that amine.

### DETAILED DESCRIPTION OF THE INVENTION

The present invention contemplates a solvent composition for removing polymerization scale, and particularly SAN scale. A contemplated composition comprises a mixture of at least five ingredients that include (i) about 30 to about 50 weight percent of mixed C₁-C₄ alkyl esters of C₃-C₁₀ dibasic acids, (ii) about 20 to about 40 weight percent dimethyl sulfoxide (DMSO), (iii) about 15 to about 25 weight percent of a C₂-C₄ carbonate, (iv) about 5 to about 15 weight percent of a C₁-C₄ ester of lactic acid, and (v) about 0.2 to about 5 weight percent of a tertiary amine having a boiling point of about 130° C. to about 370° C. at one atmosphere of pressure.

A contemplated solvent mixture thus contains dimethyl sulfoxide (DMSO), a polar, aprotic solvent in an amount of about 20 to about 40 weight percent of the mixture. Preferably, DMSO is present in an amount of about 30 weight percent.

The contemplated solvent mixture also contains a mixture of three ester-type solvents. One is a diester of a mixture of dicarboxylic acids, a second is a lactate ester, and the third is a C₂-C₄ carbonate, which is viewed as an ester herein and is the basis for use of the term “ester-like” in that the other two ingredients are true esters.

More specifically, mixed C₁-C₄ alkyl esters of C₃-C₁₀ dibasic acids play a role as a useful bridging solvent, helping to maintain a homogeneous solution and helping to dissolve assorted components. Mixed C₁-C₄ alkyl esters of C₃-C₁₀ dibasic acids are well known in the art, and therefore need not be more specifically described. These diesters are present at about 30 to about 50 weight percent of total solvent composition, and more preferably at about 30 weight percent.

For use here, particularly preferred mixed C₁-C₄ alkyl esters of C₃-C₁₀ dibasic acids include methyl esters of C₄-C₆ dibasic acid esters that are commercially available from DuPont Nylon Intermediates and Specialties, Wilmington, Del. under the designation DBE™. Seven DBE™ fractions are available that differ in the amounts of each of three diesters (dimethyl adipate [C₆,] dimethyl glutarate [C₅] and dimethyl succinate [C₄]) present. Each of the products is useful, with the material sold as DBE™-1 being preferred. That material is said by its manufacturer to contain 21 weight percent dimethyl adipate, 59 weight percent dimethyl glutarate and 20 weight percent dimethyl succinate. The material designated as DBE™-3 is said by its manufacturer to contain 89 weight percent dimethyl adipate, 10 weight percent dimethyl glutarate and 0.2 weight percent dimethyl succinate.

A C₁-C₄ ester of lactic acid can be present at about 5 to about 15 weight percent of the solvent composition, and is preferably present at about 10 weight percent. The C₁-C₄ ester of lactic acid is preferably an ethyl (C₂) ester. Exemplary C₁-C₄ alcohols that can comprise the C₁-C₄ ester portion of a lactate ester include methanol, ethanol, propanol, isopropanol, allyl alcohol, butanol, 3-buten-1-ol, t-butanol and sec-butanol.

A C₂-C₄ carbonate is the third ester-type component of the solvent composition. A C₂-C₄ carbonate can be present in an amount of about 15 to about 25 weight percent, and preferably about 20 weight percent of the solvent composition. Propylene carbonate, a C₃ carbonate, is preferred.

A tertiary amine having a boiling point of about 130° C. to about 370° C. at one atmosphere of pressure is present in the solvent composition in an amount of about 0.2 to about 5 weight percent of the total composition weight, and preferably at about 0.5 weight percent. The preferred tertiary amines are those that are relatively non-volatile and have boiling points in the range of the boiling points of the other components of the formulation; i.e., the esters and DMSO. Moreover, the preferred tertiary amines do not easily volatilize from the formulation and provide an ammonia-like odor.

Exemplary tertiary amines can be found in catalogues and handbooks well-known to those skilled in organic chemistry. The most useful tertiary amines are aliphatic and include N,N-dimethyl-ethanolamine (DMEA), N,N-diethylethanolamine (DEEA) and triethanolamine (TEA). Other useful tertiary amines include 3-dimethylamino-1-propanol, tripropylamine, triiso-propylamine, triallylamine, the aromatic 2-, 3- and 4-picolines, 2,3-lutidine, 2,4-lutidine, 2,5-lutidine, 2,6-lutidine, 3,4-lutidine, and 3,5-lutidine. Use of a single tertiary amine is preferred, but mixtures of two or more tertiary amines are also contemplated.

The use of a tertiary amine in the solvent composition unexpectedly provided stability during recycling distillation. It is thought that the tertiary amine provides mild alkalinity and pH buffering in the vapor phase of distillation and thereby substantially reduced the hydrolysis of the esters that occurs during distillation.

The tertiary amine also appears to have simultaneously reduced degradation of the DMSO during the distillation process of recycling. Still further, the tertiary amine provides an effective stabilizing agent for preventing a reaction between the esters in the formulation and DMF as can exist during the transition phase of switchover from use of DMF for scale removal, where these two materials can be mixed together. The reaction of the esters with the amide (DMF) produces dimethylamine, which has a strong, objectionable “fish” odor.

To further mask any other odors, a small amount of an ester fragrance having a boiling point at one atmosphere that is about that of the other ingredients such as methyl salicylate (wintergreen oil) can also be added. An odor-masking amount of such a fragrance is present and that amount is typically about 0.2 to about 5 weight percent of the solvent composition. The amount of fragrance present in the solvent composition can depend upon the fragrance as well as the other ingredients present, as is well-known.

A particularly preferred composition contains the following weight percentages of the enumerated ingredients.

| | |
|---|---|
| Dibasic esters—DBE ™-1 (Dupont) | 39% |
| Dimethyl sulfoxide (DMSO) | 30% |
| Propylene carbonate | 20% |
| Ethyl lactate | 10% |
| Triethanolamine | 0.5% |
| Methyl salicylate | 0.5% |

### EXAMPLE 1

### Initial Cleaner Formulation and Test Results (Prior Art)

An initial solvent composition formulation denominated RZ-1 contained three ester-based solvents (dibasic ester DBE-1, ethyl lactate and propylene carbonate) and one aprotic dipolar solvent dimethyl sulfoxide (DMSO). These are all readily biodegradable and have low toxicity. A typical formulation contained (% w/w):

| | |
|---|---|
| Dibasic esters—DBE ™-1 (Dupont) | 40% |
| Dimethyl sulfoxide (DMSO) | 30% |
| Propylene carbonate | 20% |
| Ethyl lactate | 10% |

Sufficient quantities of the above formulation were produced to be tested for SAN scale removal in reactors. These test results showed that solvent RZ-1 could meet several of the specified design criteria for an improved solvent formulation.

First, RZ-1 was formulated from four benign, readily biodegradable solvents that included biodegradable solvents. This provides a significant improvement over the more toxic and environmentally hazardous DMF.

Second, solvent RZ-1 significantly reduced SAN process equipment cleaning time. A blend of only 20 percent RZ-1 with 80 percent DMF reduced the cleaning time required from the previous 24 hours to 17 hours, a 29 percent reduction.

The third design objective of recyclability by vacuum distillation could only be partially met. This shortcoming of the composition became apparent with ongoing use of the product. The solvent RZ-1 blend was susceptible to thermal degradation during the recycling operation. The DMSO component was observed to decompose to low molecular weight sulfur compounds as a temperature of 150° C. was approached, especially under acidic conditions. This decomposition reduces the cleaning effectiveness of the RZ-1 product in subsequent cleaning cycles, and also generates dimethyl disulfide, which has a very objectionable (rotten egg) odor.

### EXAMPLE 2

### Exemplary Solvent Composition

A stabilized formulation denominated RZ-2 was developed using the readily biodegradable components described in the Example above with the minor additions of a key component and a cosmetic component. The key component was a tertiary amine, whereas the cosmetic component, was an odor-masking agent that is also a readily biodegradable ester.

An improved formulation, which is the subject of the current invention, was created. An example of typical formulation contained (% w/w):

| | |
|---|---|
| Dibasic esters—DBE ™-1 (Dupont) | 39% |
| Dimethyl sulfoxide DMSO | 30% |
| Propylene carbonate | 20% |
| Ethyl lactate | 10% |
| Triethanolamine | 0.5% |
| Methyl salicylate | 0.5% |

A sample of the composition of this Example was tested in the pilot-scale in a SAN pilot plant reactor. The formulation readily dissolved the scale and cleaned the reactor in much (about 50 percent) shorter time than the previous DMF cleaner. During recycle of the solvent by vacuum distillation around a temperature of 120° to 130° C., increased thermal stability and much reduced odor generation were observed. As DMF is phased out and the concentration of RZ-2 is increased, cleaning cycle times will be reduced further. When 100 percent RZ-2 is used, a cleaning cycle time of 5 to 6 hours is projected (a 75 percent reduction) from the data in hand.

Each of the patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

What is claim:

1. A solvent composition a mixture of at least five ingredients that comprises (i) about 30 to about 50 weight percent C₁-C₄ alkyl esters of mixed C₃-C₁₀ dibasic acids, (ii) about 20 to about 40 weight percent dimethyl sulfoxide (DMSO), (iii) about 15 to about 25 weight percent of a C₂-C₄ carbonate, (iv) about 5 to about 15 weight percent of a C₁-C₄ ester of lactic acid, and (v) about 0.2 to about 5 weight percent of a tertiary amine having a boiling point of about 130° C. to about 370° C. at one atmosphere of pressure.

2. The solvent composition according to claim 1 wherein said C₁-C₄ alkyl esters of mixed C₃-C₁₀ dibasic acids are methyl esters of mixed C₄-C₆ dibasic acid esters.

3. The solvent composition according to claim 1 wherein said C₂-C₄ carbonate is propylene carbonate.

4. The solvent composition according to claim 1 wherein said C₁-C₄ ester of lactic acid is ethyl lactate.

5. A solvent composition a mixture of at least five ingredients that comprises (i) about 30 to about 50 weight percent methyl esters of mixed C₄-C₆ dibasic acid esters, (ii) about 20 to about 40 weight percent dimethyl sulfoxide (DMSO), (iii) about 15 to about 25 weight percent propylene carbonate, (iv) about 5 to about 15 weight percent of ethyl lactate, and (v) about 0.2 to about 5 weight percent of a tertiary amine having a boiling point of about 130° C. to about 370° C. at one atmosphere of pressure.

6. The solvent composition according to claim 5 wherein said tertiary amine is aliphatic.

7. The solvent composition according to claim 5 wherein said tertiary amine is aromatic.

8. The solvent composition according to claim 5 wherein said tertiary amine is present at about 0.5 weight percent of said composition.

9. The solvent composition according to claim 5 wherein said tertiary amine is selected from the group consisting of N,N-dimethylethanolamine, N,N-diethylethanolamine, triethanolamine, 3-dimethylamino-1-propanol, tripropylamine, triiso-propylamine, triallylamine, the aromatic 2-, 3- and 4-picolines, 2,3-lutidine, 2,4-lutidine, 2,5-lutidine, 2,6-lutidine, 3,4-lutidine, and 3,5-lutidine, and mixtures thereof.

10. The solvent composition according to claim 5 wherein said propylene carbonate is present at about 20 weight percent.

11. The solvent composition according to claim 5 wherein said ethyl lactate is present at about 10 weight percent.

12. The solvent composition according to claim 5 wherein said methyl esters of mixed C₄-C₆ dibasic acid esters present at about 30 weight percent

13. The solvent composition according to claim 5 wherein said DMSO is present at about 30 weight percent.

14. A solvent composition a mixture of at least five ingredients that comprises (i) about 40 weight percent methyl esters of mixed C₄-C₆ dibasic acid esters, (ii) about 30 weight percent dimethyl sulfoxide (DMSO), (iii) about 20 weight percent propylene carbonate, (iv) about 10 weight percent ethyl lactate, and (v) about 0.2 to about 5 weight percent of a tertiary amine having a boiling point of about 130° C. to about 370° C. at one atmosphere of pressure.

15. The solvent composition according to claim 14 wherein said tertiary amine is aliphatic.

16. The solvent composition according to claim 14 wherein said tertiary amine is present at about 0.5 weight percent of said composition.

17. The solvent composition according to claim 14 wherein said tertiary amine is selected from the group consisting of N,N-dimethylethanolamine, N,N-diethylethanolamine, triethanolamine, 3-dimethylamino-1-propanol, tripropylamine, triiso-propylamine, triallylamine, and mixtures thereof.
